(19) United States
(12) Patent Application Publication
(10) Pub. No.: US 2011/0158379 A1
(43) Pub. Date: Jun. 30, 2011

(54) COMPUTED TOMOGRAPHY SYSTEM HAVING NANO-SPATIAL RESOLUTION

(75) Inventors: Kwon-Soo CHEON, Seoul (KR); Kwon Ha Yoon, Jeollabuk-do (KR)

(73) Assignee: Wonkwang University Center for Industry Academy Cooperation, Jeollabuk-do (KR)

(21) Appl. No.: 12/647,323

(22) Filed: Dec. 24, 2009

(51) Int. Cl. H05G 1/60

(52) U.S. Cl. 378/4

(57) ABSTRACT

Provide is a computed tomography (CT) system having a nano-spatial resolution. The computed tomography system can obtain a 3-dimensional image having the nano-spatial resolution of less than about 100 nm from a 2-dimension image generated by limiting a thickness of a bio sample such as cells and micro-tissues or an industrial solid sample such as a semiconductor chip to a thickness of less than about 100 μm, enlarging an X-ray transmitting the sample to a high magnification of greater than about 100× using a diffractive optic having a magnification of greater than about 100× such as a zone plate, and condensing the X-ray. When the CT system having the nano-spatial resolution is used, the 3-dimensional image having the nano-spatial resolution of less than about 100 nm may be obtained from the bio sample and industrial solid sample having a thickness of less than about 100 μm that is not observed using a conventional CT system including a cone-shaped light source unit. Therefore, an internal structure (an internal short-circuit of a semiconductor chip) of the sample may be very easily detected.

### BACKGROUND OF THE INVENTION

1. Field of the Invention

The present invention relates to a computed tomography (CT) system, and more particularly, a CT system having a nano-spatial resolution, which can obtain a three-dimensional CT image having a spatial resolution of less than about 100 nm through a sample having a thickness of about 100 μm.

2. Description of the Related Art

CT systems are apparatuses that can obtain a three-dimensional (3-D) image through an object. The CT systems are mainly used for obtaining 3-D images to detect lesions in the human body as well as for experiments using animals.

FIG. 1 is a view of a conventional CT system 100 that is widely used in hospitals. The CT system 100 includes a cone-shaped light source unit 110, an image detecting unit 120, and an image processing unit 130. The CT system 100 is classified into a sample rotation type and a gantry rotation type according to an image acquisition method. In case of the gantry rotation type, the light source unit 110 and the image detecting unit 120 are integrated with each other.

The cone-shape light source unit 110 generates an X-ray using an X-ray tube light source to irradiate a cone-beam onto a sample S.

The image detecting unit 120 detects the X-ray transmitting the sample S to generate two-dimensional (2-D) images of the sample S. Typically, a charge-coupled device (CCD) camera, a complementary metal oxide semiconductor (CMOS) camera, and a flat panel detecting unit are used as the image detecting unit 120.

The image processing unit 130 reconstructs the 2-D images generated in the image detecting unit 120 using a cone-beam image reconstruction algorithm to generate 3-D images.

For example, according to the above-described conventional CT system 100, the image detecting unit 120 generates 360 2-D images while the sample S is rotated 360 times with 1 degree step, or the image detecting unit 120 generates 360 2-D images while the cone-shaped light source unit 110 and the image detecting unit 120, which are integrated with each other, are rotated 360 times with 1 degree step. The image processing unit 130 reconstructs the generated 2-D images using the cone-beam image reconstruction algorithm to generate the 3-D images.

As described above, the conventional CT system 100 that is widely used in hospitals is required to provide high resolution of the obtained 3-D images in order to precisely detect lesions. A spatial resolution of such 3-D images is affected by a light source size of the cone-shaped light source unit 110 and a pixel size of the image detecting unit 120.

In fact, blurring of the sample S is in inverse proportion to the light source size in a state where a light source spot of the cone-shaped light source unit 110 is limited to its size. Thus, as the light source size of the cone-shaped light source unit 110 gradually decreases, a high spatial resolution of the 3-D images may be obtained. In addition, as the pixel size of the image detecting unit 120 gradually decreases, the high spatial resolution of the 3-D images may be obtained.

### SUMMARY OF THE INVENTION

When the light source size of the cone-shaped light source unit 110 is reduced to improve the spatial resolution of the 3-D image, the number of photon generated in the X-ray tube light source is reduced. In addition, an exposing time for obtaining an image of the image detecting unit 120 increases. Particularly, since it is difficult to reduce the spot size of the X-ray tube light source into a size of less than several micrometers μm, it is very difficult to set the 3-D image having a spatial resolution of less than about 1 μm.

Also, when the pixel size of the image detecting unit 120 is reduced to improve the spatial resolution of the 3-D image, there is a limitation that the pixel size of the image detecting unit 120 is reduced to a size of less than several micrometers μm due to the detection efficiency and noise occurrence. To overcome the limitation, the magnification (it is actually difficult to obtain a magnification higher than 10 times) of the image detecting unit 120 increases instead of the reduction of the pixel size of the image detecting unit 120 to obtain an effect similar to that of the reduction of the pixel size of the image detecting unit 120. However, when the magnification of the image detecting unit 120 increases, the image blurring may occur to deteriorate the spatial resolution.

Thus, it is nearly impossible to obtain a 3-D image having the spatial resolution of less than about 1 μm using the conventional CT system 100 including the cone-shaped light source unit 100.

Therefore, to overcome the above-described limitations, an object of the present invention is to provide the CT system, which can obtain the 3-D image having the nano-spatial resolution of less than about 100 nm from the 2-D image generated by limiting the thickness of the bio sample such as the cells and micro-tissues or the industrial solid sample such as the semiconductor chip to a thickness of less than about 100 μm, enlarging the X-ray transmitting the sample to the high magnification of greater than about 100× using the diffractive optic having the magnification of greater than about 100× such as the zone plate, and condensing the X-ray.

To achieve these objects of the invention, there is provided a computed tomography system having a nano-spatial resolution, including: a light source unit generating an X-ray using an X-ray tube light source; a collimator limiting the X-ray radiated at a predetermined angle from the light source unit in a vertical or horizontal direction; a monochromator reflecting the X-ray including a polychromatic beam transmitting the collimator using a multi-layer mirror aligned at a specific bragg angle according to bragg reflection condition to extract only a monochromatic characteristic X-ray; a capillary optic condensing the monochromatic characteristic X-ray extracted by the monochromator to irradiate the condensed monochromatic characteristic X-ray onto a sample; a stopper disposed at a front end of the capillary optic to prevent the X-ray from being directly transmitted into the capillary optic without being reflected by an inner wall of the capillary optic; a sample state fixing the sample to be observed to a capillary tube or a sample holder mounted on a stage that is translatable, inclined, and rotatable; a diffractive optic enlarging and condensing the monochromatic characteristic X-ray transmitting the sample such that the monochromatic characteristic X-ray transmitting the sample fixed to the sample stage is detected to enlarge a 2-dimensional image of the sample S to a specific magnification; an image detecting unit detecting the monochromatic characteristic X-ray enlarged by the diffractive optic to generate the 2-dimensional image; and an image processing unit reconstructing the 2-dimensional image generated by the image detecting unit using a parallel-beam image reconstruction algorithm to generate a 3-dimensional image.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view of a conventional computed tomography (CT) system;

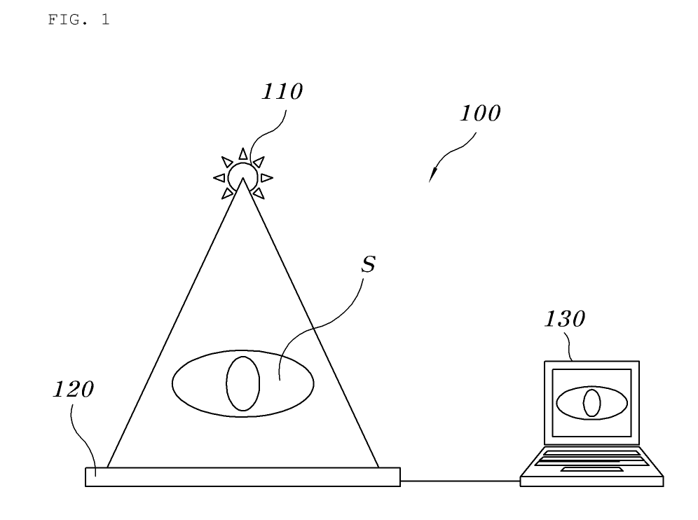

FIG. 2 is a view of a CT system having a nano-spatial resolution according to an embodiment of the present invention; and

FIG. 3 is a view of a CT system having a nano-spatial resolution according to another embodiment of the present invention.

### DETAILED DESCRIPTION OF THE INVENTION

Hereinafter, the present invention will be described in detail with reference to the accompanying drawings.

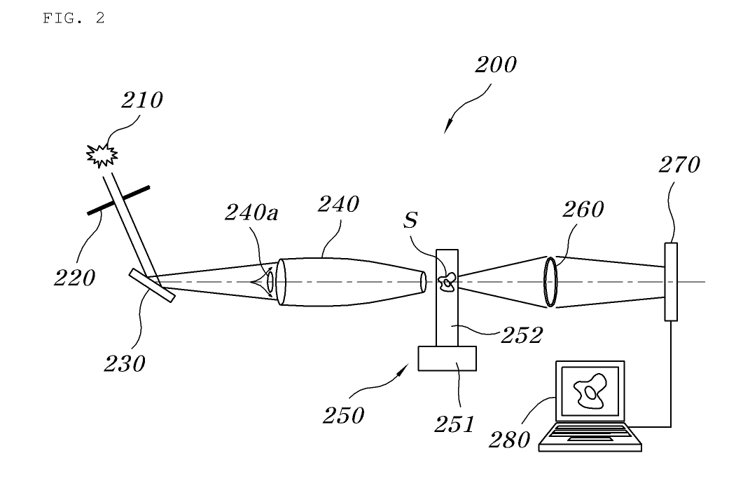

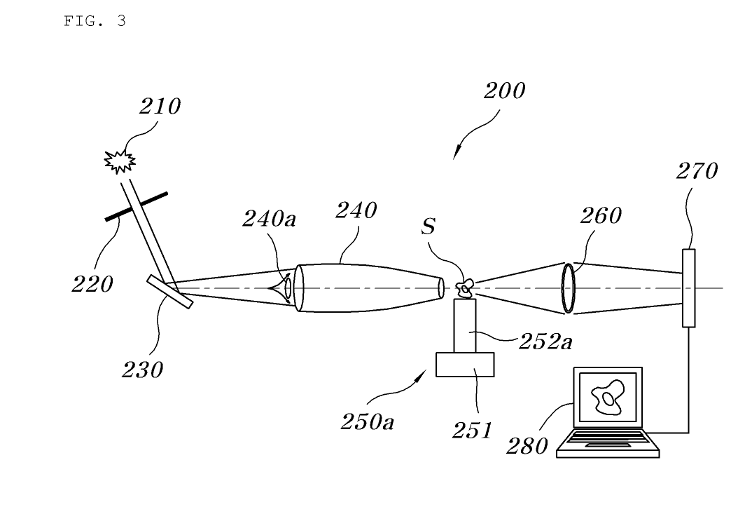

Referring to FIGS. 2 and 3, a light source unit 210 generates an X-ray using an X-ray tube light source.

The light source unit 210 may be formed of a target material having a specific radiation ranging of about 5 keV to about 10 keV to effectively observe bio samples and industrial samples. The target material may include chrome (Cr_{Kα}, 5.4 keV), copper (Cu_{Kα}, 8.0 keV), and tungsten (W_{Lα}, 8.4 keV).

A collimator 220 limits the X-ray radiated at a predetermined angle from the light source unit 210 in a vertical or horizontal direction and has a slit width of several hundred micrometers (μm).

A monochromator 230 reflects the X-ray including a polychromatic beam transmitting the collimator 220 using a multi-layer mirror aligned at a specific bragg angle according to a bragg reflection condition to extract only a monochromatic characteristic X-ray. For reference, when the bragg reflection condition λ=2d sin θ (here, d is a thickness, θ is an incident angle, and λ is an X-ray wavelength) is used, an average thickness of the multi-layer mirror and uniformity of layers constituting the multi-layer may be calculated to align the multi-layer mirror at the specific bragg angle so as to extract only the monochromatic characteristic X-ray having a high reflective efficiency. For example, to effectively reflect an X-ray of about 8.4 keV including the polychromatic beam transmitting the collimator 220 to extract only the monochromatic characteristic X-ray, a thickness of the multi-layer mirror may be set to about 5.65 nm, and a bragg angle may be set to about 0.8°.

A capillary optic 240 condenses the monochromatic characteristic X-ray extracted by the monochromator 230 to irradiate the condensed monochromatic characteristic X-ray onto a sample S.

The capillary optic 240 may be designed to totally reflect the monochromatic characteristic X-ray when the capillary optic 240 has a diameter of about 200 μm. Also, the capillary optic 240 may have a length of about 120 mm even through the length of the capillary optic 240 is varied according to a desired X-ray energy.

The capillary optic 240 may be formed of Pyrex glass having a low melting point. Also, the capillary optic 240 may have an oval shape to irradiate the X-ray onto the sample S.

A stopper 240a is disposed at a front end of the capillary optic 240 to prevent the X-ray from being directly transmitted into the capillary optic 240 without being reflected by an inner wall of the capillary optic 240. The stopper 240a may be formed of a metal material such as gold (Au) and nickel (Ni).

A sample stage 250 or 250a fixes the sample S to be observed to a capillary tube 252 or a sample holder 252a mounted on a stage 251 that can be translated, inclined, and rotated.

An air bearing stage in which an angle adjustment is easy and a rotation error is very small may be used as the stage 251.

As shown in FIG. 2, the bio sample S (e.g., cells and micro-tissues) is put into the capillary tube 252. The capillary tube 252 should have a thickness of less than about 100 μm. Thus, there is a limitation that a large-sized bio sample S should be split into a size of less than about 100 μm to observe the sample S several times because the large-sized bio sample S is not directly applied.

As shown in FIG. 3, an industrial solid sample S that does not fall down is mounted on the sample holder 252a. The sample S mounted on the sample holder 252a should have a thickness of less than about 100 μm.

When the X-ray is irradiated onto the sample S mounted on the sample stage 205 or 250a for a long time, the sample S may increase in temperature or be deformed in structure because of a dose of the X-ray accumulated in the sample S. Thus, when the bio sample S is used, a temperature regulator or a cryo-system may be utilized to maintain the bio sample S at a specific temperature (e.g., about 4° C.).

A diffractive optic 260 enlarges and condenses the monochromatic characteristic X-ray transmitting the sample S such that the monochromatic characteristic X-ray transmitting the sample S fixed to the sample stage 250 or 250a is detected to enlarge a 2-D image of the sample S to a specific magnification.

A zone plate may be used as the diffractive optic 260 to enlarge the 2-D image to a high magnification (e.g., magnification of greater than about 100×). In the level of the present technique, a unique X-ray optic having the magnification of greater than about 100× is the zone plate. For reference, to secure a 3-D image having a spatial resolution of greater than about 100 nm, a 2-D image may have a spatial resolution of about 80 nm greater than that of the 3-D image. Also, to secure the 2-D image having the spatial resolution of about 80 nm, it is required that the zone plate has the outermost width of about 50 nm. In addition, it is required that the zone plate has an aspect ratio of greater than about 10 to improve diffraction efficiency. Also, when the zone plate is designed, a focal length of the CT system having the nano-spatial resolution according to the present invention should be adjusted such that the CT system has a size corresponding to a volume of a laboratory. The focal length of the CT system may be below about 10 mm.

An image detecting unit 270 detects the monochromatic characteristic X-ray enlarged by the diffractive optic 260 to generate the 2-D image. At this time, a charge-coupled device (CCD) camera or a complementary metal oxide semiconductor (CMOS) camera base on a pixel that can generate a 2-D digital image may be used as the image detecting unit 270. For reference, the number of pixels of the CCD camera or the CMOS camera based on the pixel may be over about 2,048×2,048, and a detection effective-area may be over 24 mm×24 mm.

A magnification of the diffractive optic 260 may be adjusted according to the pixel size and the detection effective-area of the image detecting unit 270.

An image processing unit 280 reconstructs the 2-D image generated by the image detecting unit 270 using a parallel-beam image reconstruction algorithm to generate a 3-D image.

An operation of the CT system 200 having the nano-spatial resolution according to the present invention will be described.

The CT system having the nano-spatial resolution of FIG. 2 according to an embodiment of the present invention and the CT system having the nano-spatial resolution of FIG. 3 according to another embodiment of the present invention have the same configuration, except that units for fixing the sample S to the sample stages 250 and 250a are different from each other according to kinds of the sample S.

That is, in FIG. 2, the bio sample S (e.g., cells and micro-tissues) is fixed to the inside of the capillary tube 252 of the sample state 250. In FIG. 3, the industrial solid sample S (e.g., semiconductor chip) that does not fall down is fixed to the sample holder 252a of the sample stage 250a.

As described above, in the state where the bio sample S (cells and micro-tissues) or the industrial solid sample S (e.g., semiconductor chip) is fixed to the sample stage 250 or 250a, when the light source unit 210 generates the X-ray, the collimator 220 limits the X-ray radiated at a predetermined angle from the light source unit 210 in a vertical or horizontal direction to transmit the X-ray to the monochromator 230.

As a result, the reflects the X-ray including the polychromatic beam transmitting the collimator 220 using the multi-layer mirror aligned at a specific bragg angle according to the bragg reflection condition to transmit the X-ray the capillary optic 240.

At this time, the monochromatic characteristic X-ray is reflected by the inner wall of the capillary optic 240 and then condensed due to the stopper disposed at the front end of the capillary optic 240.

Then, the monochromatic characteristic X-ray condensed by the capillary optic 240 is irradiated onto the bio sample S (cells and micro-tissues) or the industrial solid sample S (e.g., semiconductor chip), which is fixed to the sample stage 250 or 250a. At this time, the monochromatic characteristic X-ray transmitting the sample S is enlarged to a specific magnification (e.g., magnification of greater than about 100×) by the diffractive optic 260 and condensed into the image detecting unit 270.

Thus, the image detecting unit 270 detects the monochromatic characteristic X-ray enlarged by the diffractive optic 260 to generate a 2-D image, thereby transmitting the 2-D image to the image processing unit 280. The image processing unit 280 reconstructs the 2-D image generated by the image detecting unit 270 using the parallel-beam image reconstruction algorithm to generate a 3-D image.

For example, whenever the sample S fixed to the sample stage 250 or 250a is rotated 360 times with 1 degree step, the image detecting unit 270 detects the monochromatic characteristic X-ray enlarged by the diffractive optic 260 to generate a 2-D image. The image processing unit 280 reconstructs the 360 2-D images generated by the image detecting unit 120 using the parallel-beam image reconstruction algorithm to generate a 3-D image.

When the CT system having the nano-spatial resolution according to the present invention is used, the 3-D image having the nano-spatial resolution of less than about 100 nm may be obtained from the bio sample and industrial solid sample having a thickness of less than about 100 μm that is not observed using the conventional CT system 100 including the cone-shaped light source unit. Therefore, an internal structure (an internal short-circuit of a semiconductor chip) of the sample may be very easily detected.

The CT system having the nano-spatial resolution according to the present invention is not limited to the above-described embodiments, and it will be apparent to those skilled in the art that various modifications and variations can be made in the present invention. Thus, it is intended that the present invention covers the modifications and variations of this invention provided they come within the scope of the appended claims and their equivalents.

What is claimed is:

1. A computed tomography system having a nano-spatial resolution, comprising:
a light source unit (210) generating an X-ray using an X-ray tube light source;
a collimator (220) limiting the X-ray radiated at a predetermined angle from the light source unit (210) in a vertical or horizontal direction;
a monochromator (230) reflecting the X-ray comprising a polychromatic beam transmitting the collimator (220) using a multi-layer mirror aligned at a specific bragg angle according to bragg reflection condition to extract only a monochromatic characteristic X-ray;
a capillary optic (240) condensing the monochromatic characteristic X-ray extracted by the monochromator (230) to irradiate the condensed monochromatic characteristic X-ray onto a sample (S);
a stopper (240a) disposed at a front end of the capillary optic (240) to prevent the X-ray from being directly transmitted into the capillary optic (240) without being reflected by an inner wall of the capillary optic (240);
a sample state (250 or 250a) fixing the sample (S) to be observed to a capillary tube (252) or a sample holder (252a) mounted on a stage (251) that is translatable, inclined, and rotatable;
a diffractive optic (260) enlarging and condensing the monochromatic characteristic X-ray transmitting the sample (S) such that the monochromatic characteristic X-ray transmitting the sample (S) fixed to the sample stage (250 or 250a) is detected to enlarge a 2-dimensional image of the sample S to a specific magnification;
an image detecting unit (270) detecting the monochromatic characteristic X-ray enlarged by the diffractive optic (260) to generate the 2-dimensional image; and
an image processing unit (280) reconstructing the 2-dimensional image generated by the image detecting unit (270) using a parallel-beam image reconstruction algorithm to generate a 3-dimensional image.

2. The computed tomography system of claim 1, wherein the diffractive optic (260) comprises a zone plate.

3. The computed tomography system of claim 1, wherein the bio sample (S) is inserted and fixed into/to the capillary tube (252) of the sample stage (250 or 250a), and the industrial solid sample (S) is mounted and fixed on/to the sample holder (252a).
